(19) United States
(12) Patent Application Publication
(10) Pub. No.: US 2003/0054810 A1
(43) Pub. Date: Mar. 20, 2003

(54) Enterprise mobile server platform

(76) Inventors: Yih-Farn Robin Chen, Bridgewater, NJ (US); Huale Huang, Kearney, NJ (US); Rittwik Jana, Pinebrook, NJ (US); Trevor Jim, Princeton, NJ (US); Sam John, Atlanta, GA (US); Serban Jora, Hackettstown, NJ (US); Radhakrishnan Muthumanickam, Somerset, NJ (US); Bin Wei, Basking Ridge, NJ (US)

Correspondence Address: DALY, CROWLEY & MOFFORD, LLP, SUITE 101, 275 TURNPIKE STREET, CANTON, MA, 02021-2310, US

(21) Appl. No.: 10/165,887

(22) Filed: Jun. 10, 2002

Related U.S. Application Data
(63) Continuation-in-part of application No. 10/037,750, filed on Jan. 2, 2002.
(63) Continuation-in-part of application No. 09/853,151, filed on May 10, 2001.
(60) Provisional application No. 60/248,816, filed on Nov. 15, 2000.
(60) Provisional application No. 60/340,908, filed on Oct. 29, 2001.
(60) Provisional application No. 60/347,110, filed on Jan. 9, 2002.

(51) Int. Cl. H04M 11/10; H04Q 7/20

(52) U.S. Cl. 455/422; 455/466; 455/412

(57) ABSTRACT

A mobile service platform includes a plurality of gateways interacting with a plurality of servers via a message queue for providing a platform allows mobile devices to communicate with each other and to securely access corporate and Internet contents and services.

### CROSS REFERENCE TO RELATED APPLICATIONS

The present application claims the benefit of U.S. patent application Ser. No. 10/037,750 filed on Nov. 9, 2001, and U.S. application No. 09/853,151 filed on May 10, 2001, which claim the benefit of U.S. Provisional Patent Application No. 60/248,816, filed on Nov. 15, 2000, all of which are incorporated herein by reference. This application also claims the benefit of U.S. Provisional Patent Application No. 60/340,908 filed on Oct. 29, 2001 and the benefit of U.S. Provisional Patent Application No. 60/347,110, filed on Jan. 9, 2002, which are incorporated herein by reference.

### STATEMENT REGARDING FEDERALLY SPONSORED RESEARCH

Not Applicable.

### FIELD OF THE INVENTION

The present invention relates generally to communication systems and, more particularly, to portable wireless communication systems.

### BACKGROUND OF THE INVENTION

As is known in the art, wireless Internet access is different from simply accessing the Internet wirelessly. Mobile wireless users have different needs, motivations and capabilities from typical wireline users. For example, a mobile user is usually in a multi-tasking mode, e.g., accessing the Internet while attending a meeting or shopping in the mall. Typical Internet accesses are bursty in nature (checking stock quotes, weather, or finding a nearby restaurant) and task-oriented. Thus, browser-centric applications and elaborate user interfaces are of limited utility since a mobile user usually carries small devices such as a cell phone or a Personal Digital Assistant (PDA) having relatively small displays. These personalized devices, which are typically identified by a wireless network address such as a cellular phone number, provide mobile users with continuous access to the Internet.

Advances in wireless networking and messaging technologies have given mobile users many choices to access Internet contents and services. Existing devices and protocols include PDAs, such as Palm Pilots with Web Clipping, cell phones with wireless application protocol (WAP) or short message service (SMS), email devices, such as Blackberry and AT&T PocketNet, supporting Post Office Protocol 3 (POP3) and/or (Internet Message Access Protocol) IMAP, and America On Line (AOL) Instant Messaging (AIM).

While such devices and protocols can provide limited Internet access, differing devices and protocols do not communicate with each other easily. Thus, business and individual mobile users must make challenging decisions to obtain mobile access in a constantly changing environment. For example, employees of a particular company may need to use a single type of device to enable wireless communication between the employees. However, one device type may not be optimal or desirable for the duties each employee must perform.

It would, therefore, be desirable to provide wireless communication for a variety of mobile device types and protocols. It would further be desirable to provide wireless communication with a variety of information spaces. It would also be desirable to readily support wireless communication for new devices and protocols.

### SUMMARY OF THE INVENTION

The present invention provides a mobile device server for providing communication with a variety of protocols and devices. The mobile device server provides a message gateway for allowing mobile devices using a range of protocols and access networks to relay messages to each other and to obtain information from a range of information spaces. With this arrangement, a mobile user can readily communicate with other mobile users having the same or different devices. A mobile user can also obtain data from a wide range of resources, such as the Internet and databases. While the invention is primarily shown and described in conjunction with portable mobile devices, it is understood that the invention is generally applicable to systems in which it would be desirable for differing device types and protocols to communicate with each other.

In one aspect of the invention, a mobile device server includes a plurality of components that cooperate to enable a mobile device to communicate with other mobile device types and with a variety of information space types. In one embodiment, a mobile device server includes an engine component that communicates with other server components and maintains user profile information. The server includes a plurality of interface components each of which corresponds to a particular device type or protocol, for example. A plurality of access components provides abstract views of respective information spaces, such as websites, databases, and corporate information. Each of a plurality of logic components processes information retrieved by one or more of the access components for transmission back to the requesting mobile device via the corresponding interface component.

The engine component communicates with the interface, access and logic components and maintains user/device profiles. In one embodiment, the engine component communicates with the interface components in a predetermined format, translates aliased user commands, invokes appropriate logic and access components, and transcodes retrieved data into a format based upon characteristics, e.g., display size, of the requesting device.

In an exemplary operation, a mobile device issues a request for the latest stock price of a particular company. The mobile device has a particular messaging client, such as America On Line's Instant Messenger (AIM). The mobile device communicates with the mobile device server via an AIM interface component, which receives the request for stock data and formats the request into a predetermined format. The engine component receives the formatted request, validates the mobile user identification, and transforms command aliases, e.g., q for “quote”.

The engine component then sends the data request to an appropriate logic component, which can, for example, determine an optimum stock quote service based upon certain criteria. The logic component then requests the engine component to invoke the appropriate access component corresponding to the selected quote service, e.g., Yahoo. The access component then utilizes the proper mechanism, e.g., Hyper Text Transfer Protocol (HTTP), to retrieve the requested content.

The retrieved raw content is returned to the engine component for examination and formatting. The engine component accesses the profile of the recipient device to which the requested information is to be sent, which may or may not be the requesting mobile device. Based upon the profile of the recipient device, the engine component invokes an appropriate access component for transcoding the retrieved raw content into the appropriate format, e.g., text only. The engine component then delivers the transcoded data to the interface component corresponding to the recipient device for transmission.

In another aspect of the invention, a mobile device server includes a plurality of gateways for interfacing with a variety of mobile device types and a plurality of servers for interacting with a variety of external information sources. In one embodiment, the gateways and the servers interact via a message queue that stores requests from the gateways and replies from the servers. In an exemplary embodiment, the gateways can each include one or more interface components and the servers can each include one or more access and/or logic components.

### BRIEF DESCRIPTION OF THE DRAWINGS

The invention will be more fully understood from the following detailed description taken in conjunction with the accompanying drawings, in which:

FIG. 1 is a schematic depiction of a mobile device server for communicating with a variety of devices and networks in accordance with the present invention;

FIG. 2 is a schematic block diagram of an exemplary architecture for the mobile device server of FIG. 1;

FIG. 3 is a schematic block diagram showing the mobile device server having a plurality of interface devlets in accordance with the present invention;

FIG. 4 is a schematic depiction of an exemplary communication path configuration (for Short Messaget Services, or SMS) for a mobile device server in accordance with the present invention;

FIG. 5 is a schematic block diagram showing the mobile device server having a plurality of access infolets in accordance with the present invention;

FIG. 6 is a schematic block diagram showing a first part of a data transfer by a mobile device server in accordance with the present invention;

FIG. 7 is a schematic block diagram showing a second part of a data transfer by a mobile device server in accordance with the present invention;

FIG. 8 is a schematic block diagram showing a third part of a data transfer by a mobile device server in accordance with the present invention;

FIG. 9 is a schematic block diagram showing a fourth part of a data transfer by a mobile device server in accordance with the present invention;

FIG. 10A is an exemplary screen display showing Internet access of flight info from an AIM device through the AIM devlet on the mobile device server in accordance with the present invention;

FIG. 10B is an exemplary screen display showing website news access from a Palm V device through the email devlet on the mobile server in accordance with the present invention;

FIG. 11A is an exemplary screen display for a device accessing a corporate database through the JDBC infolet on the mobile device server in accordance with the present invention;

FIG. 11B is an exemplary screen display for a mobile phone accessing a corporate database through the JDBC infolet on the mobile device server in accordance with the present invention;

FIG. 12 shows an exemplary screen display for a device requesting service from a CORBA object through the AIM devlet on the mobile device server in accordance with the present invention;

FIG. 13 is an exemplary screen display for a device controlling X10 home network devices through the AIM devlet on the mobile device server in accordance with the present invention;

FIG. 14 is an exemplary screen display for a device accessing an inbox of an E-mail account through the AIM devlet on the mobile device server in accordance with the present invention;

FIG. 15 is a pictorial representation of an applet for finding a movie for a mobile user of a mobile device server in accordance with the present invention;

FIG. 16 is a schematic representation of an instant messaging mechanism for a mobile device server in accordance with the present invention;

FIG. 17 is a schematic block diagram of an enterprise mobile device server in accordance with the present invention;

FIG. 17A is a block diagram showing a gateway having a plurality of components that can form a part of an enterprise mobile device server in accordance with the present invention;

FIG. 17B is a block diagram showing an exemplary embodiment having end-to-end encryption from a mobile device to an enterprise server in accordance with the present invention;

FIGS. 18A-C show screen displays for an exemplary access and authentication associated with an enterprise mobile device server in accordance with the present invention;

FIG. 19 is an exemplary schematic block diagram showing secure access to an enterprise mobile device server in accordance with the present invention;

FIG. 19A is a block diagram of a server that can form a part of an enterprise mobile device server in accordance with the present invention;

FIG. 19B is a block diagram of an exemplary infolet that can form a part of an enterprise mobile device server in accordance with the present invention;

FIG. 20 is a block diagram demonstrating exemplary sessions associated with an enterprise mobile device server in accordance with the present invention;

FIG. 21 is a data model subset of exemplary entity/relationships for an enterprise mobile device server in accordance with the present invention;

FIGS. 22A-B show exemplary screen displays for a messaging application for various devices supported by an enterprise mobile device server in accordance with the present invention; and

FIG. 23 shows an exemplary screen display for remote control video recording and delivery for an enterprise mobile device server in accordance with the present invention.

### DETAILED DESCRIPTION OF THE INVENTION

In general, the present invention provides a mobile device server that operates as a message gateway for allowing mobile devices using various protocols on different access networks to communicate with each other. The mobile device server also allows mobile clients to access resources and information on the Internet and various other networks. The mobile device server includes a flexible architecture having a plurality of components that cooperate to service mobile communication requests. Mobile device server components include an engine component communicating with interface devlets, logic applets, and access infolets. The incoming mobile service requests, sent through a variety of communication protocols, are intercepted at a gateway. The protocols can range from user-defined (special purpose protocol e.g., military) to a standardized (HTTP) mechanism. The native requests are packaged and injected into a message queue. The message queue relays each request to a server. Each server communicates with a back end application or an “information space” to fulfill the request via an interface defined by an infolet. This arrangement allows the mobile device server to readily support new devices and protocols by adding corresponding devlets, infolets, and applets without altering the existing service logic.

As described more fully below, interface gateways or devlets receive and send messages through a particular protocol used by various mobile devices. Access infolets utilize particular access methods to provide an abstract view of respective information spaces. And logic applets implement service or application logic by processing information from one or more infolets. The let engine provides the basic framework for maintaining applets, devlets and infolets, supporting user and device profiles for personalization and transcoding, and invoking proper applets and infolets to answer data requests from devlets.

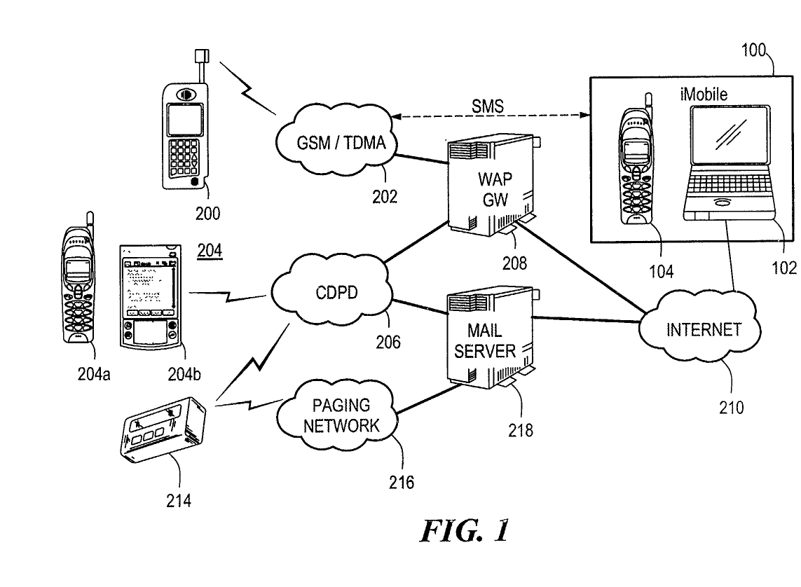

FIG. 1 shows an exemplary embodiment of a mobile device server 100 for enabling mobile users to communicate with a variety of devices and protocols in accordance with the present invention. The mobile device server 100 can run on a computer 102 having connections to a plurality of networks and devices. It is understood that the mobile device server can operate on a variety of known computers and operating systems, such as Unix and Windows. In one embodiment, the mobile device server 100 is implemented using the Java programming language running in a Windows, Solaris, or Linux environment.

The mobile device server 100 further includes a mobile phone device 104 for receiving and transmitting data via wireless communication. The mobile phone 104 can support Short Message Service (SMS) communication, which is well known to those skilled in the art. While shown as a wireless phone coupled to the computer, it will be readily apparent to one of ordinary skill in the art that mobile device server functionality can be readily integrated into a single device. In addition, the mobile device server can include a number of wireless devices, which can be the same or different type, coupled to the computer 102.

The mobile device server 100 enables communication between various devices and networks. In the illustrated embodiment, a cell phone 200 with two-way short messaging service (SMS), e.g., a Global System for Mobile Communication/Time Division Multiple Access (GSM/TDMA) phone connected to a GSM/TDMA network 202, can communicate with the mobile device server 100 through an SMS driver hosted on the mobile device server. Cellular Digital Packet Data (CDPD) devices 204, such as AT&T PocketNet phone 204a and Palm V 204b, coupled to a CDPD network 206 can use a Wireless Access Protocol (WAP) gateway 208 to access the mobile device server 100 through the Internet 210. Email devices 214, such as a Blackberry mobile device, can use the Standard Email Protocol (SMTP) on the CDPD network 206 or a two-way paging network 216 coupled to a mail server 218 to communicate with the mobile device server 100.

In addition, PC device users and some PDAs can use AOL Instant Messenger (AIM) or web browsers to communicate with the mobile device server 100, which can support a Transmission Control Protocol (TCP) interface. Mobile devices can include an embedded module for communicating with the mobile device server 100 directly via the TCP interface. The mobile device server 100 can receive messages and commands from these devices, access Internet services and information on behalf of a mobile user, and relay messages or Internet content back to the sending devices or other devices, as described more fully below.

The mobile device server 100 includes an architecture having a plurality of interface, logic, and access components that enable the mobile device server to communicate with a range of devices, protocols and information spaces. This arrangement hides the complexity of multiple devices and content sources from mobile users. The mobile device server 100 can include a proxy server that provides an environment for hosting agents and personalized services, which can be implemented as reusable building blocks in the Java programming language, for example. An exemplary proxy server known as iProxy, is shown and described in U.S. patent application Ser. No. 08/974,600, filed on Dec. 19, 1997, and U.S. patent application Ser. No. 09/474,914, filed on Dec. 30, 1999, which are incorporated herein by reference. In general, an iProxy agent, which can include a web-server, can be invoked like a regular common gateway interface (CGI) program. The iProxy system also allows scripts embedded inside web pages to invoke agents to perform specialized processing. The iProxy system maintains user profiles and adds intelligence to the traditional HTTP proxy server to provide personalized, and value-added services such as filtering, tracking, and archiving.

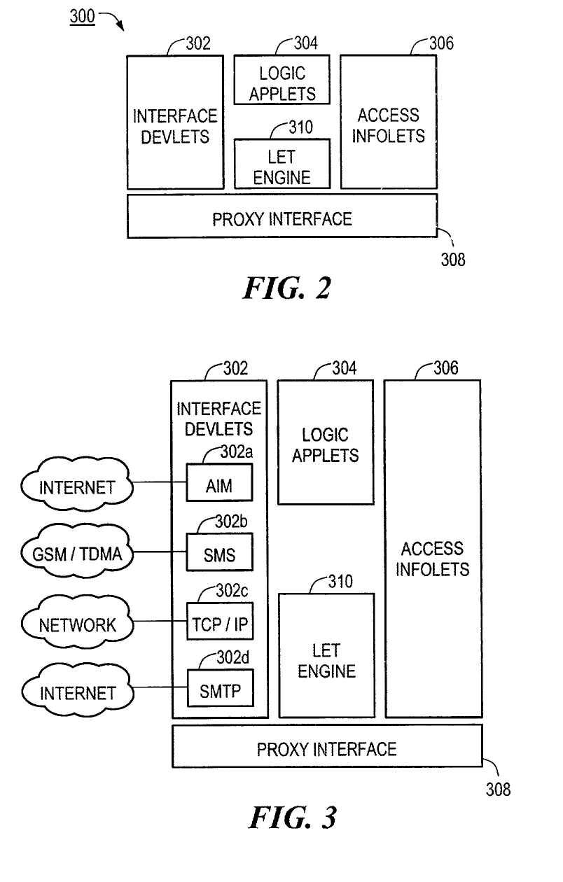

FIG. 2 shows an exemplary architecture for a mobile device server 300 having a plurality of components that combine to provide a flexible architecture that can readily support new devices, interfaces and information spaces. In one particular embodiment, the mobile device server 300 includes interface devlets 302, logic applets 304 and access infolets 306. The devlet, infolet, and applets 302, 304, 306, as well as a proxy interface 308, communicate with each other through a let engine 310. These components can be implemented as iProxy agents.

As shown in FIG. 3, each interface devlet 302 provides a protocol interface to a given device on a particular access network. As described above, exemplary access network types include the Internet, CDPD, and GSM/TDMA, each of which is supported by one or more corresponding interface devlets. In the illustrative embodiment, an AIM devlet 302a, a GSM/TDMA devlet 302b, a TCP/IP devlet 302c, and a SMTP/IMAP devlet 302d are shown for communicating with the corresponding networks. It is understood that further interface devlets can be provided for a variety of additional protocols well known to one skilled in the art. For example, email devlets can include SMTP, IMAP and POP3 interfaces for sending and retrieving email.

The interface devlets 302 interact with the let engine 310 via a predetermined interface format. In one particular embodiment, the devlets 302 provide requests to the let engine 310 in character-stream command lines and the let engine returns results in Multipurpose Internet Mail Extensions (MIME) format. After the mobile device server 300 is initialized, each interface devlet 302 monitors a respective channel for incoming requests sent by a remote mobile device. For example, the AIM devlet 302a on the mobile device server starts an AIM client for listening to service requests from other AIM clients sent as instant messages.

It is understood that the required device driver can form a part of a corresponding interface devlet 302 or can communicate with the devlet through a TCP protocol, for example. This approach allows a device driver to run on a remote machine, i.e., a device other than on the mobile device server.

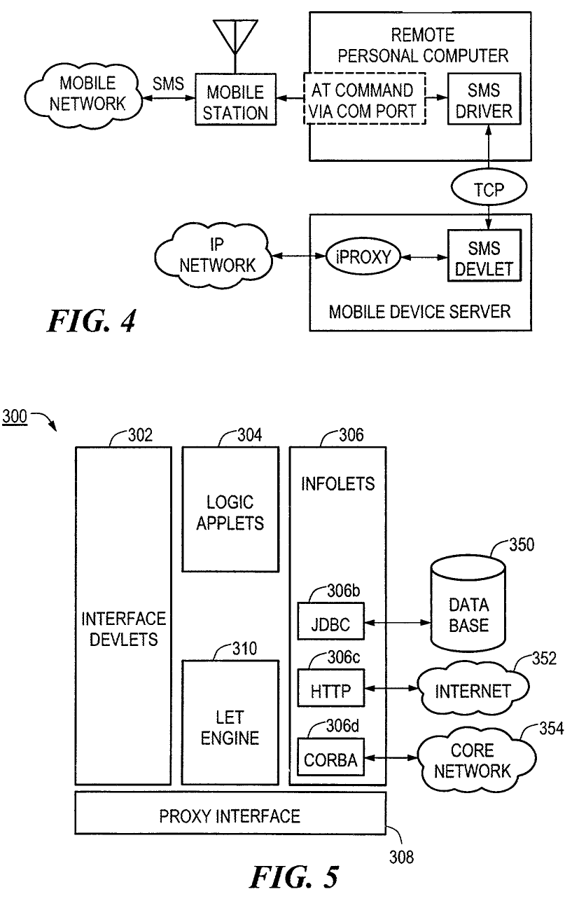

FIG. 4 shows an exemplary communication path between an SMS mobile station MS and a mobile device server MDS in accordance with the present invention. An SMS devlet running on the mobile device server MDS communicates with a GSM cell phone MS attached to a remote personal computer RPC through an SMS driver. Mobile users can send messages to the cell phone MS (through the GSM network), which then forwards each message to the mobile device server MDS for processing. The mobile device server MDS then returns the result to the mobile user through the same channel. Such an arrangement is further shown and described in U.S. Provisional Application No. 60/206,167 entitled “Mobile Phone Internet Access Utilizing Short Message Service Method and Apparatus,” filed May 22, 2000, which is incorporated by reference herein.

Similarly, to allow access to the mobile device server through email, a mobile device server email devlet can monitor messages arriving at a particular email account for new service requests. For TCP users, a TCP session is created upon receiving a request to connect with a particular port of the mobile device server machine using the telnet protocol. The telnet user can enter mobile device server commands as if using a typical Unix or Windows terminal, for example. The mobile device server can also support the WAP and HTTP protocols through the proxy interface 308 (FIG. 2).

Referring again to FIG. 2, while each protocol and device can have unique interfaces, each corresponding interface devlet 302 interacts with the let engine 310 in a predetermined format. More particularly, a devlet 302 can send a data request in the form of a character stream, interpreted as a mobile device server command and associated parameters, to the let engine 310. The devlet 302 can receive results from the let engine 310 in a Multipurpose Internet Mail Extensions (MIME) format appropriate for the device, which is determined by the corresponding device profile stored at the let engine. Device profiles contain information for user devices, such as how much information can be displayed.

A simplified version of the mobile device server command syntax is listed below:

<command> :=[ <forward_command><destinations> ]

<applet_command> [ <applet_argument> ]*

<destinations> := <destination> [“,”<destination> ]*
<destination> := <protocol>“:” <account_id>

In this particular embodiment, the naming of each device or destination follows the conventional URL naming scheme: protocol name followed by an account name or address. For example, typical destination addresses include “sms:+19735556242” (GSM cell phone), “aim:sunshineX” (AIM buddy name), “mail:iproxy@research.att.com (email id)”, etc.

As described more fully below, after receiving the command, the let engine 310 invokes one or more logic applets 304 that implement the required logic for the data request. The let engine 310 then invokes the access infolet 306 appropriate for the information space to be accessed.

Referring briefly to FIG. 5, the access infolets 306 extend beyond the HTTP protocol and URL name space to provide abstract views of various information spaces, such as databases 350, Internet information sources 352, core networks 354, and X10 home devices. Corresponding access infolets, such as Java Data Base Connectivity (JDBC) 306a, http 320b, CORBA 306c infolets access the respective information spaces as shown. A given interface infolet 306 retrieves information from a particular information space, such as stock quote sites, weather sites, and airline flight databases. It is understood that the same information may be accessed using a variety of access protocols. For example, such information is commonly available on many websites, and may also be retrieved from XML files or databases. An interface infolet retrieves the original content and returns it to an appropriate applet 304 for further processing, as described more fully below.

As an example of a mobile station request to access the stock price of AT&T (stock symbol T), the mobile device user can issue a “quote T” command. If the request is sent by a mobile user using SMS on the GSM network, then the result will be returned as plain text to the requesting GSM cell phone. If the mobile user wants to forward the result to an email address, e.g., herman@research.att.com, the user issues a “forward mail:herman@research.att.com quote T” command. Since that email account understands the MIME type text/HTML (according to the device profile), the result will be sent by the let engine as an HTML file, complete with graphics, to the herman@research.att.com email account.

The interface devlets 302 allow users on different networks to readily communicate with each other. For example, if a GSM phone user wants to send a message to other devices, such as an AT&T PocketNet mail account, e.g., chen@mobile.att.net, which is on the CDPD network, and an AT&T TDMA phone having phone number 555-500-6531 using SMS, then an echo applet can use a message relay service as follows: “forward mail:chen@mobile.att.net, attmsg:5555006531 echo call your boss.”

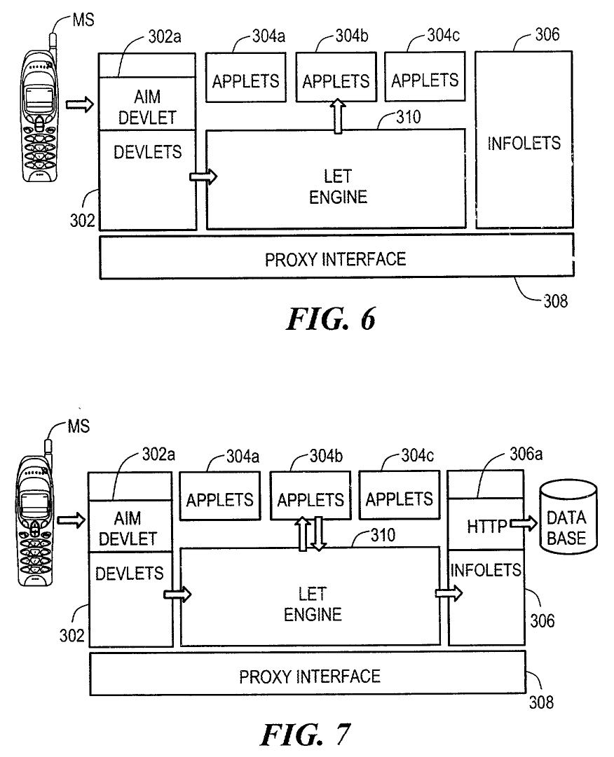

FIGS. 6-9 show an exemplary transaction between a mobile device MS and a mobile device server 300 in accordance with the present invention. As shown in FIG. 6, the mobile device MS, such as a Palm Vx with a CDPD modem having an AIM client, issues a “q T” (quote AT&T-stock symbol T) command, which requests that the mobile device server 300 retrieve the current price of AT&T stock. The Palm Vx MS establishes a communication channel with the mobile device server 300 via an AIM devlet 302a, e.g., imobile4att. The AIM devlet 302a receives the instant message from the Palm Vx device and formats the message into a predetermined format, e.g., “q T” in text, prior to passing the message to the engine component or let engine 310. The engine component 310 transforms any aliases, e.g., q for quote, defined by the mobile device user and authenticates the user. The engine component 310 then invokes the appropriate logic applet 304b, which can implement predetermined logic for selecting a stock quote service, such as MSN, Yahoo, Etrade, etc.

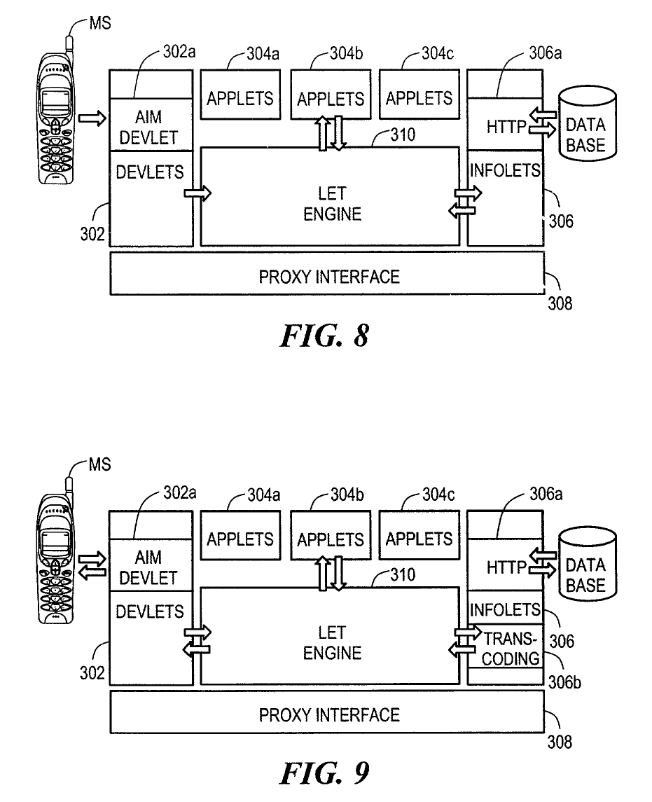

As shown in FIG. 7, the logic applet 304b then requests the let engine 310 to invoke the appropriate, e.g., http, access infolet 306a. In FIG. 8, the access infolet 306a retrieves the request stock information using the mechanism, e.g., http, appropriate for the selected quote service. The infolet 306a then returns the raw data, which can be in HTML format, to the let engine 310.

As shown in FIG. 9, the let engine 310 examines the raw data, as well as profile data for the recipient device, which can be the same or different from the requesting mobile device MS. For example, the mobile device MS can request data to be forwarded to a specified device, such as an email account. Based upon the profile of the recipient device, the let engine 310 can send the raw data to the transcoding component of an infolet 306b for processing. In the case where the recipient device accepts only text in messages less than 1000 bytes, the transcoding component 306b transcodes the raw data accordingly. After the infolet converts the data into text, the let engine 310 then delivers the text message to the AIM devlet 302a, if the Palm Vx device MS is the recipient device.

It is understood that the mobile device server of the present invention can communicate with a wide variety of mobile device types. In addition, the architecture of the mobile device server can readily support new functionality with applets, new devices with devlets, and new information spaces with infolets.

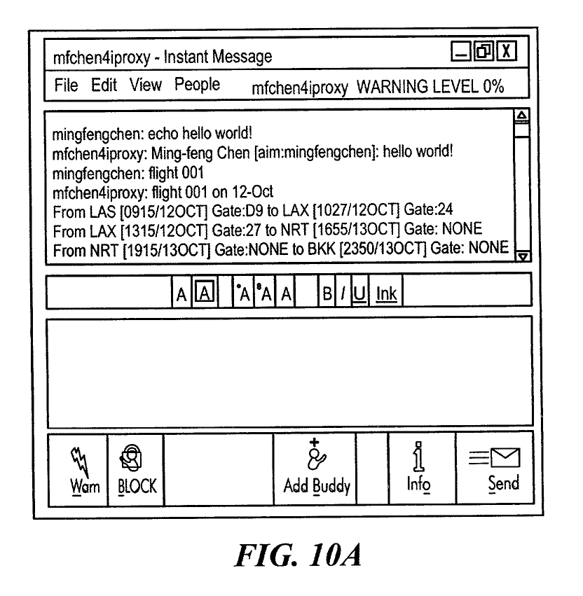

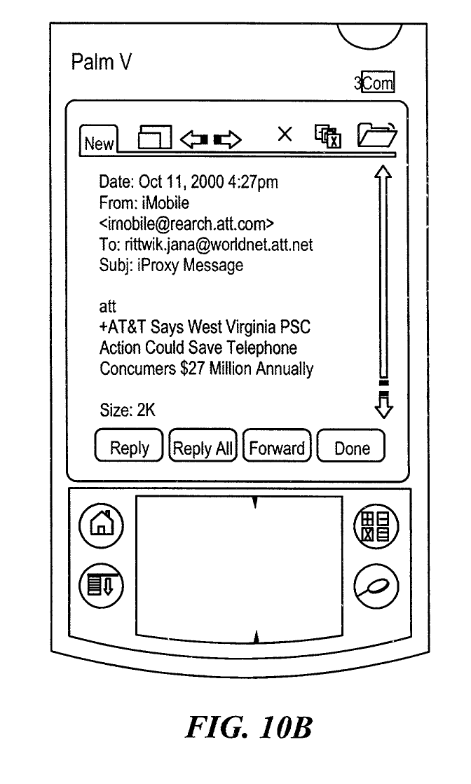

FIG. 10A shows an AIM client, mingfengchen, on an exemplary mobile device that talks to the mobile device server AIM agent, mfchen4iproxy. The AIM client issues the “flight 001” command to get flight information on a particular airline and receives output including time and gate information for each leg of the flight. Mapping from the flight command to the airline can be controlled by a corresponding logic applet according to the user profile. Also, the let engine invokes necessary transcoding services to map the elaborate content on the airline website to the receiving device according to AIM device's profile.

FIG. 10B shows a Palm V device having an Omnisky modem that just sent an email to the mobile device server email devlet at imobile@gresearch.att.com with the command “sitenews att.” This command instructs the mobile device server to access the service provided by AT&T's Website News, which reports new hyperlinks on AT&T's website (http://www.att.com). The result is sent back as an email formatted for the Palm V device.

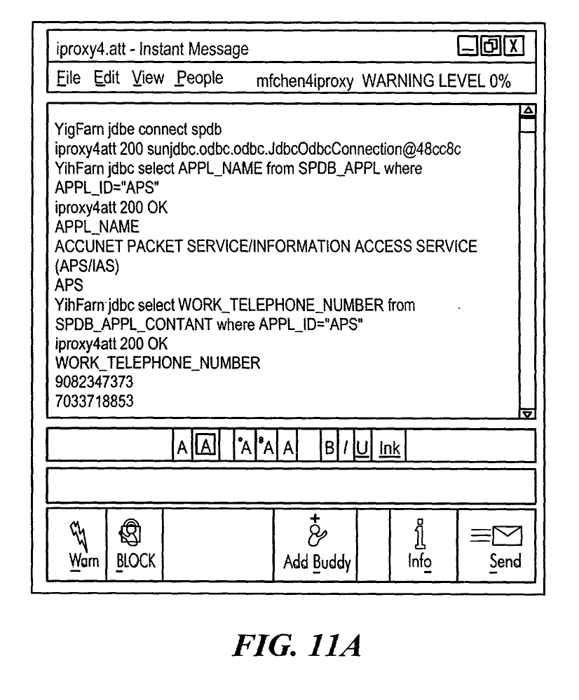

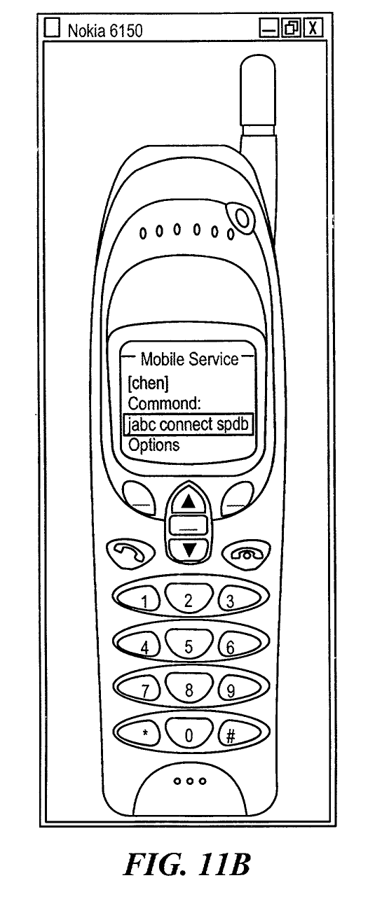

FIG. 11A shows a mobile user connecting to an enterprise database through an AIM client to find contact numbers for a particular software application using the mobile device server of the present invention. FIG. 11B shows how to access the same information from a cell phone that supports the WAP protocol. Corporate Information is typically accessed through JDBC and ODBC interfaces. The mobile device server includes a JDBC infolet that allows mobile users to access enterprise database information (marketing/sales data, system interface, etc.) through SQL-like queries.

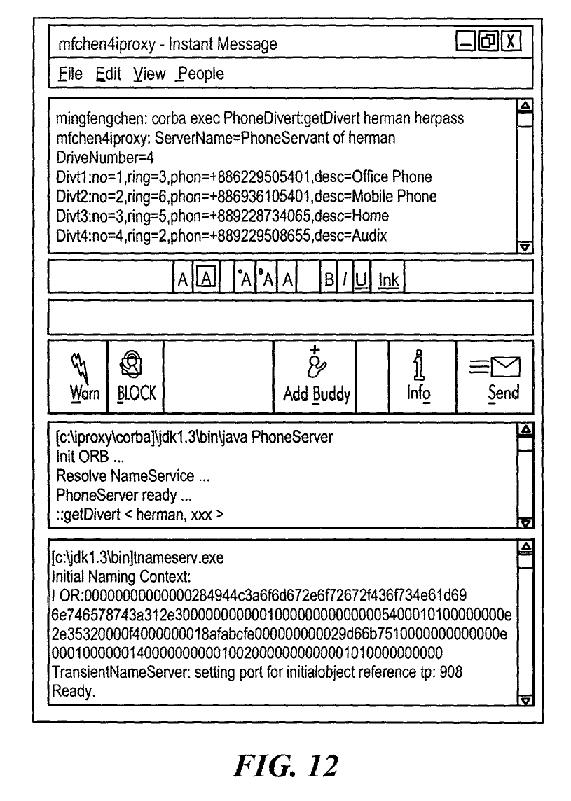

Network/Infrastructure Resources are typically accessed through the CORBA (Common Object Request Broker Architecture) interface. As known to one of ordinary skill in the art, CORBA is an architecture and specification for managing distributed program objects in a network to allow programs at different locations to communicate through an “interface broker.” The mobile device server hosts a CORBA infolet that allows mobile users to request services from CORBA objects. FIG. 12 shows how an AIM user gets phone diversion information for the user Herman.

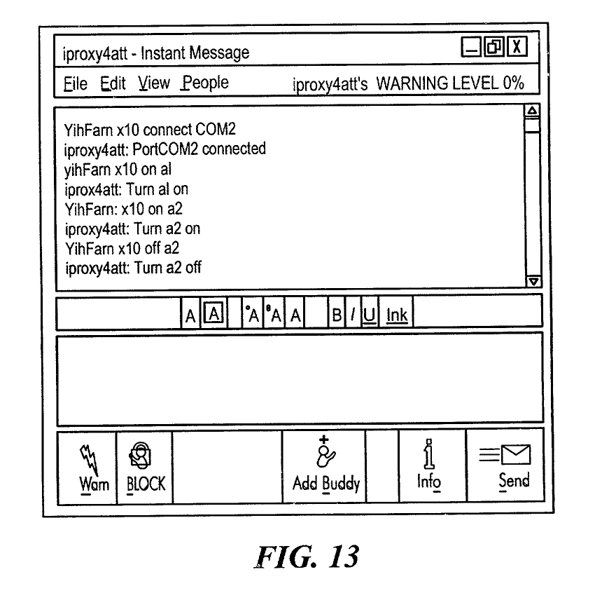

FIG. 13 shows a mobile device user controlling X10 devices remotely via the mobile device server of the present invention. The X10 home network technology allows lamps and appliances connected on the same power line to be controlled by a computer. The mobile device server hosts an X10 infolet that controls home network devices connected to its server machine. First, the user instructs the mobile device server to locate the firecraker, the device that is capable of sending a radio signal to a transceiver device on the X10 network, through the serial port COM2 on the mobile device server host. After the connection is established, a command, e.g., “x10 on a1” is sent to turn on the fan (which is named device a1 on that particular X10 network) and “x10 on a2” to turn on the coffee pot. The X10 interface allows a mobile user to control the lighting and appliances at home with a GSM cell phone, an AIM client, or an email device anywhere in the world. The X10 infolet also demonstrates that an infolet can be used to both retrieve and change the state of an information space. An applet based on X10 infolets can use an algorithm to determine when and how to activate certain X10 infolets to control a home environment.

Further application for utilizing the mobile device server to access home network devices will be readily apparent to one of ordinary skill in the art. For example, motion sensors can be activated and de-activated using a mobile device, such as a cell phone. A user can instruct a recording device to tape a television program using the mobile device server. It is understood that a variety of devices can be used to access a home network. That is, a user can utilize any of a cell phone, PC, PDA, Palm device, etc. to manipulate home network devices. It is further understood that while the mobile device server is primarily described as supporting mobile devices, non-mobile devices such as desktop PCs can communicate with the mobile device server.

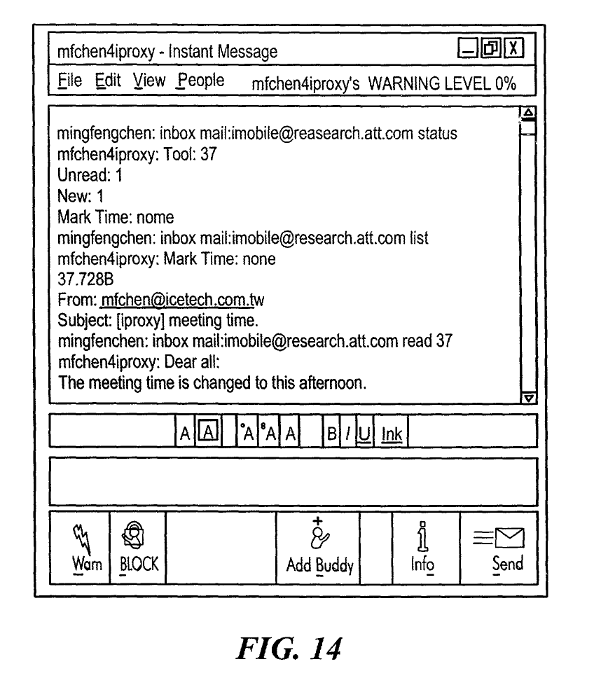

FIG. 14 shows a mobile user accessing an email account via a mobile device server in accordance with the present invention. The mobile user first checks the status of the inbox to find the number of unread messages. The mobile device server supports an IMAP infolet called inbox that can query and view a user's email account. The mobile user can look at the size, e.g., 728 bytes, subject, and sender of that message before actually viewing it. Such interaction is advantageous for a mobile user with limited bandwidth and screen space on a mobile device.

As described above, an applet implements business, service, or application logic by processing contents from different sources and relaying results to various destination devices. A simple applet is the “echo” applet described above, which sends a message from one device to another without using any information sources. It is understood that an applet can also have relatively complex interactions with other infolets.

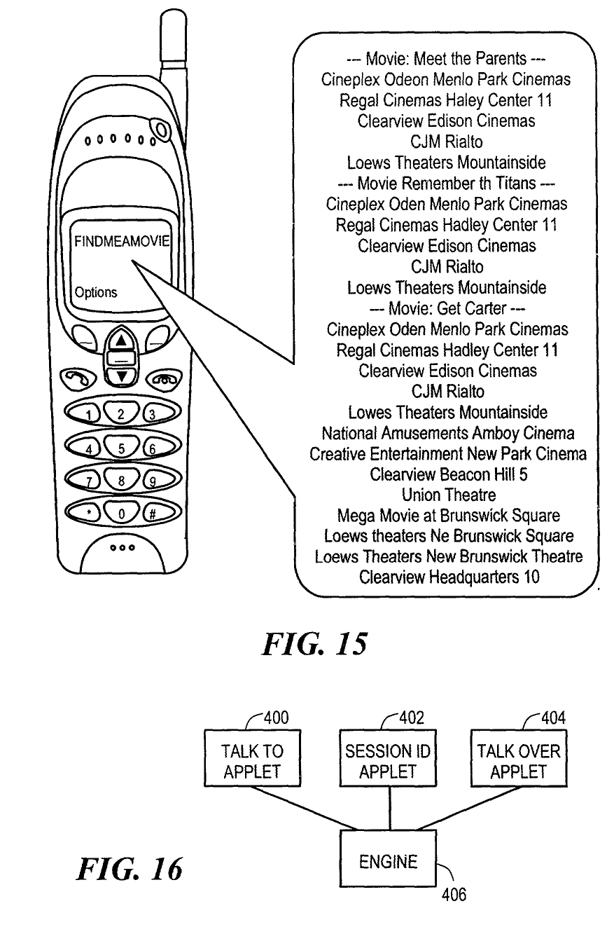

As show in in FIG. 15, for example, a FindMeAMovie applet can be implemented as an iProxy script as shown below.

#!/iproxy/script
# get the localtion information (zip)
:javabin infoLet zip getlocation
# get top10 movies (mlist)
:javabin infoLet mlist top10 movie
:foreach mtitle ${mlist}
# Find theaters
-- Movie:${mtitle}--
:javabin infoLet thlist findTheater ${mtitle} ${zip}
:foreach theater ${thlist}

# List the title & theater
${theater}

:endfor

:endfor

This applet finds theaters near a cell phone user that are currently showing the top ten movies by executing the following steps: 1) find out the location (zip code) of the cell phone user, 2) find the top 10 movies from a movie database or website, 3) for each of these movies, find out if any local theater shows that movie, and 4) list the move title and the theater.

In general, each devlet, infolet, and applet must be registered at the let engine first before communications with other agents can occur. Each abstract device that communicates with the mobile device server must register its profile information with the let engine first. A device name is designated by protocol and account ID, i.e., protocol:acct_id. For example, an AIM user webciao is named aim:webciao. The mobile device server maintains a default profile for each device type, and each instance of a device can overwrite that profile with device-specific information. A device profile can simply be a list of attribute-value pairs. An important attribute is dev.format.accept, which determines what MIME type the device is allowed to accept. This information is used by the mobile device server to transcode original content to a format appropriate for this device, as described above. For example, the default profile for an email device is the following and can be named mail.ini in the directory in which device profiles are kept:

dev.format.accept=text/html,*/*

dev.page.size=−1

The above device profile indicates that the default MIME type is text/html, but all MIME types(*/*) are acceptable. Also, the page size “−1” indicates that there is no limit on the size of each message transmission. These values are inherited by all mail devices unless they are overwritten. For example, while the two default values might be valid for primary email devices (desktop or laptop PC's), they are not appropriate for emails used on cell phones, such as AT&T's PocketNet phone. The following device profile for a PocketNet phone indicates that only the MIME type text/plain is appropriate for this device and that it does not accept messages longer than 230 characters:

dev.format.accept=text/plain dev.page.size=230

A devlet can require additional information that tells the mobile device server how and when to access this device. For example, the following profile for the address imobile@research.att.com, used by the email devlet of the mobile device server, specifies the frequency (every 10 seconds) of checking the email account (store.checktime), the account password (store.url), the transport protocol for sending email (transport.url), last time the user accessed the account (cmd.lasttime), etc.

mail.store.checktime=10000

mail.store.url=imap://imobile:password@bigmail

mail.transport.url=smtp://bigmail

. . .

In general, each device is mapped to a registered user of the mobile device server. Significant reasons for this mapping arrangement include limiting access to legitimate users of the mobile device server; and personalizing a service based on the user profile. An illustrative device-to-user map stored in the server (rarp.ini) is set forth below:

sms:+886935551826=herman

sms:+19085556842=chen

mail:dchang@research.att.com=difa

aim:webciao=chen . . .

It is understood that the mobile device server of the present invention can rely upon a variety of authentication techniques. Since the mobile device server interacts with multiple networks and protocols, the server relies on different authentication mechanisms. In one embodiment, the mobile device server uses the cell phone identification on wireless phone networks, AOL buddy names on the AIM network, and generic user ID and password information for WAP, HTTP, and telnet clients. However, the mobile device server itself does not have control over the security afforded by some of these networks. Alternative embodiments can include the SSH Secure Shell to provide end-to-end authentication services. In general, the technique used by the mobile device server to authenticate a mobile user depends on the device or protocol used. Trusting wireless networks, such as Voicestream/GSM and AT&T TDMA networks, to provide the correct cell phone id when a short message (SMS) is received is generally acceptable unless a cell phone is stolen and the user did not lock the phone with a security password. The mobile device server can also trust the AOL network authentication for non-critical services. User authentication through the mobile device server itself is required if the user accesses the mobile device server through telnet, WAP, or HTTP. Following is a typical and simple user profile:

name=Robin Chen

password=xf2gbH3

default=$mail.1

# my addresses

sms.1=sms:+19085556842

mail.1=mail:chen@research.att.com

mail.2=mail:imobile@mobile.att.net

mail.all=$mail.1,$mail.2

aim.1=aim:webciao

# command aliases

sms.cmd.q=quote

sms.cmd.sn=sitenews

# address aliases

sms.addr.cc=aim:chrischen

This user profile stores the user name, password, and a list of the devices that the user registers with the mobile device server. It also stores command and address aliases. When a user accesses the mobile device server through AIM using the id webciao, the mobile device server determines from the user-device map that the user is chen and uses the user profile chen.ini for all later service requests from this device. For example, the following short message sent from a GSM phone: “forward $mail.1 q T” is interpreted as “forward mail:chen@research.att.com quote T” according to the user profile. The special character “$” requests that the mobile device server map the named device, i.e., mail.1, to its corresponding entry in the profile.

In a further embodiment, the mobile device server supports event driven message generation to one or more users. In general, a user is considered to have previously requested such information when the predetermined event occurs. For example, in the event that a child is absent from school a message is sent to the parents cell phone. The message can be sent to a plurality of devices associated with the parent to ensure that the message is noticed. In addition, messages can be schduled for delivery at predetermined times. For example, a scheduler applet can periodically check for scheduled events. For example, the mobile device server can send a message to a device at a predetermined time to alert a person that a daily medication should be taken. It is understood that a user can be mapped to multiple devices in the user profile. For example, a user can add to a daily journal located in a one address location via multiple devices, such as a cell phone, PDA, and PC.

FIG. 16 shows an exemplary embodiment of mobile device server components for supporting an instant messaging mechanism among a plurality of devices. In one embodiment, the instant messaging mechanism includes a talkto applet 400, a session ID applet 402, and a talkover applet 404. The talkto applet is invoked by the engine component 406 in response to a users request for instant messaging with another device, which can be of the same or different type. The engine component then generates the session ID applet 402 for providing a session ID to each device participating in the instant messaging. The name of the applet corresponds to the session ID, which is shared by the instant messaging users. The talkover applet 404 terminates parties from the instant messaging session. When all of the parties have left the session, the session ID applet 402 ceases to exist.

In another aspect of the invention, an enterprise mobile device server provides a platform that can deliver end-to-end mobile solutions for relatively large enterprises. Since mobile users frequently have access only to the public Internet or wireless networks, the enterprise mobile device server or platform should provide a gateway or tunneling solution to allow mobile employees to access corporate information on their intranet. This requires the platform to interact with corporate authentication services (such as Microsoft Windows domain authentication or RADIUS, Remote Authentication Dial-In User Service. Etc.). Since the platform acts on behalf of the mobile user to access corporate resources, the platform should obtain authorization based on the user identity, channel security, and corporate policy before accessing corporate databases, directories and email servers, etc. The platform should log resource accesses and operation details for accounting purposes. The platform should also be able to handle a large number of service requests concurrently coming from various wireless and landline networks. For example, an enterprise can easily have from about 10,000 users to about 200,000 or more mobile device users. In addition, the traffic mix may change dynamically and may include short messages from cell phones, instant messages, emails, and HTTP, WAP, and telnet requests. The platform should also be able to reconfigure itself dynamically when certain machines fail or become overloaded and continue to deliver services satisfying appropriate performance guarantees.

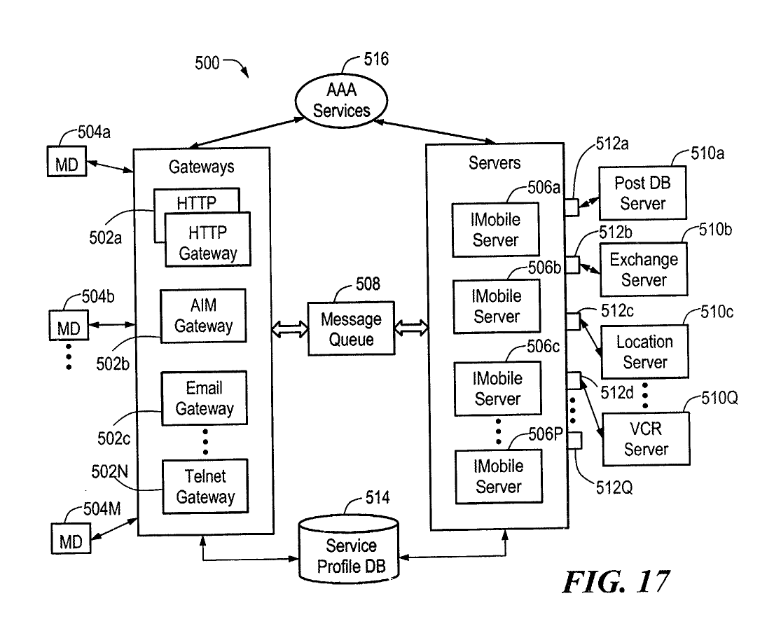

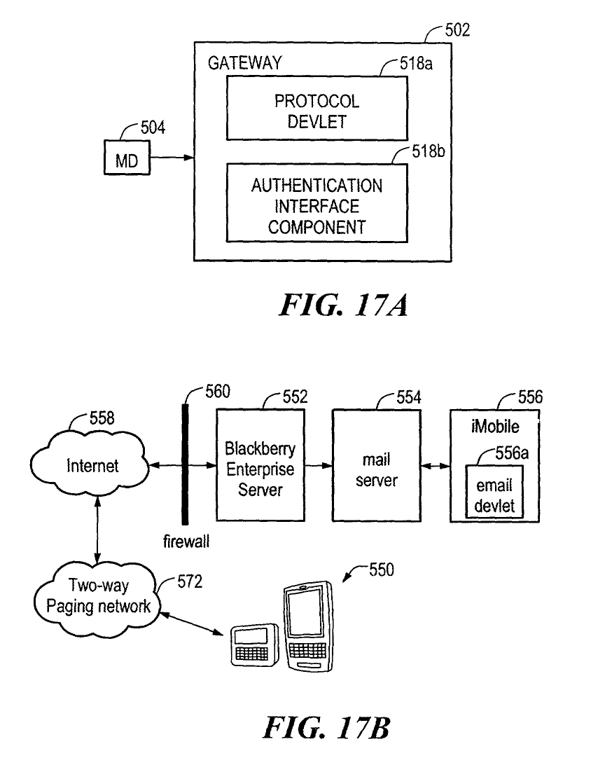

FIG. 17 shows an exemplary enterprise mobile device server or platform 500 including a plurality of gateways 502a-N that interact with mobile devices 504a-M supported by the platform. The mobile devices 504 communicate with one of the gateways 502 before accessing a respective one of a plurality of iMobile servers 506a-P via a message queue 508. The servers 506 interface with a variety of external servers 510, such as a Post DB server 510a, a Microsoft Exchange E-mail server 510b, a location server storing the location coordinates of mobile users 510c, and a video controller/server 510Q. Exemplary additional types of external information sources or spaces include databases via ODBC, JDBC drivers, distributed object interaction via CORBA, http web requests, X10, email, and documents in XML. Respective infolets (access components) 512a-Q can facilitate communication between the iMobile servers 506 and the external servers 510.

The gateways 502 authenticate mobile device users 504 and place each service request on the message queue 508. One of the iMobile servers 506 can then pick up the request in the message queue 508. The gateways 502 and servers 506 interact with a device profile database 514, which governs the transcoding templates to be used depending on the exit protocol. That is, the user can issue a request by means of a first protocol (entry protocol e.g., HTTP) and may desire the result of that request to be received or forwarded to someone else via another protocol (exit protocol). An AAA service 516 provides authentication, authorization and accounting to the gateways and servers 506, as is also described below.

In an exemplary embodiment shown in FIG. 17A, each gateway 502 may include a protocol devlet 518a and an authentication interface component 518b, which can interact with various external authentication services. In one particular embodiment, the devlet 518a is implemented as a Java servlet running inside a so-called Jakarta/Tomcat type servlet container, which is well known to one of ordinary skill in the art. In one embodiment, the number of active gateways can be dynamically adjusted based upon the average traffic load. Each gateway 518 implements a protocol and authenticates the mobile users 504 against iMobile's corporate authentication service, for example, Windows domain authentication by means of Kerberos. By issuing the login credentials (username and password) iMobile can then check against a trusted third party (e.g., Microsoft Active Directory) to allow/disallow entry.

It is understood that the enterprise mobile device platform 500 can include a wide variety of gateway types including HTTP 502a, AIM 502b, E-mail 502c, and Telnet 502N gateways shown in FIG. 17, as well as ICQ, SMS, XMS, WAP, SMTP, IMAP, POP3, and IVR. With this arrangement, the platform can support a wide variety of mobile device types.

Referring again to FIG. 17, the HTTP gateway 502a supports the HTTP protocol for mobile devices using this protocol. For the HTTP protocol, secure remote access to the iMobile HTTP gateway 502a from outside a firewall can be achieved using a variety of systems and techniques. For example, the Absent authentication system from AT&T Labs enables Web users to authenticate themselves from the public Internet by using a one-time password scheme for client authentication and SSL (Secure Socket Layer) for confidentiality.

It is understood that the iMobile system 500 can offer a client implementation within a handheld mobile device, such as an iPAQ or a Palm device with a CDPD modem, that interacts with the challenge-response mechanism in the Absent system. The imobile user 504 types in the secret pass phrase without manually going through a complex key computation and data entry process.

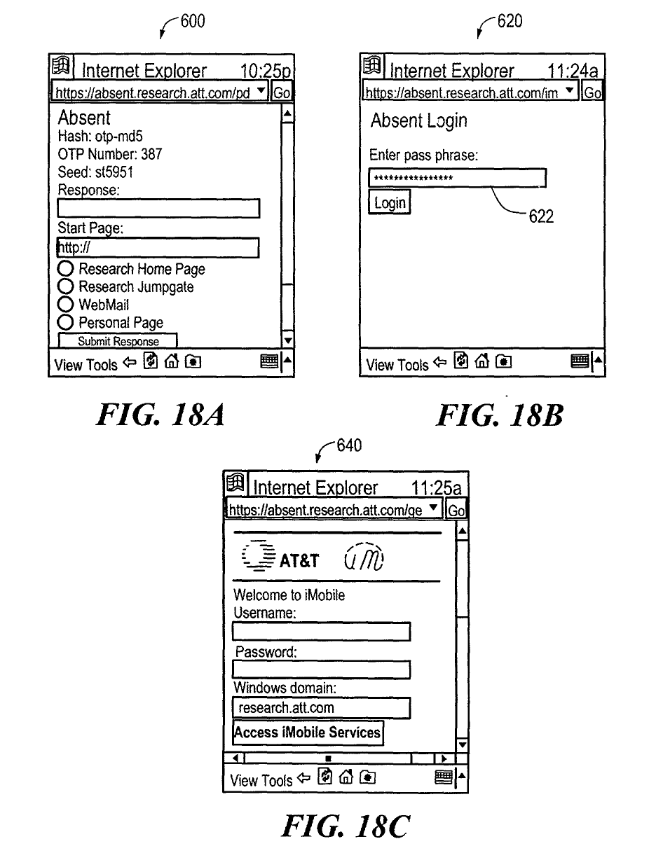

FIGS. 18A-C shows respective screenshots 600, 620, 640 for the use of the Absent system in the present invention. FIG. 18A shows a standard Absent authentication screen 600 for mobile devices, which requires a companion piece of software for automatic calculation of one-time password authentication. Such software is well known to one of ordinary skill in the art. FIG. 18B shows a simplified and customized screen 620 for quick access to the immobile system including a secret pass phrase 622. And FIG. 18C shows an exemplary iMobile HTTP gateway screen 640. Note that the Absent system allows users to get back to their intranet. The iMobile platform 500 then maps the user to either a unique user id in its own system or uses a corporate authentication service, such as the Windows domain authentication through Microsoft Active Directory, for example.

Alternatively, the iMobile platform 500 can use the so-called RADIUS scheme provided by Cisco Systems for allowing mobile users to dial up from an appropriate mobile device, such as a Visor Palm device with a GSM modem, to connect to a RADIUS server. In this case, the iMobile platform uses the RADIUS user database instead of its own to perform authentication.

It is understood that regardless of the authentication scheme, access to various backend services, such as a Microsoft Exchange Server 510b (FIG. 17), corporate database servers, etc., may require additional authentication if the iMobile system is external to the authoritative domains of the backend services. To avoid multiple authentications, the iMobile system 500 can include a so-called Single Sign-On (SSO) mechanism whereby a single user authentication permits a user to access computers and systems for which access permissions exist without the need to enter multiple passwords. Single sign-on reduces human error and is therefore desirable. Single Sign-On mechanisms are well known to one of ordinary skill in the art.

With secure wireless access, the iMobile system 500 can extend the conventional SSO capability to mobile users accessing enterprise resources from personal/handheld devices. The iMobile system should guarantee the secrecy of user passwords after service provisioning, during which a mobile user provides account information through HTTPS. In an exemplary embodiment, the iMobile system 500 stores user ID and password information in a database to provide access to backend services automatically. Otherwise, the user would need to provide such information for each service, such as the employee database, project database, and E-mail, each of which can have specific access requirements.

As is well known to one of ordinary skill in the art, WAP is an open specification that offers a standard method to access Internet-based content and services from wireless devices, such as mobile phones and PDAs (Personal Digital Assistants). Known web browsers and WAP browsers on mobile devices can share the same iMobile HTTP gateway implementation.

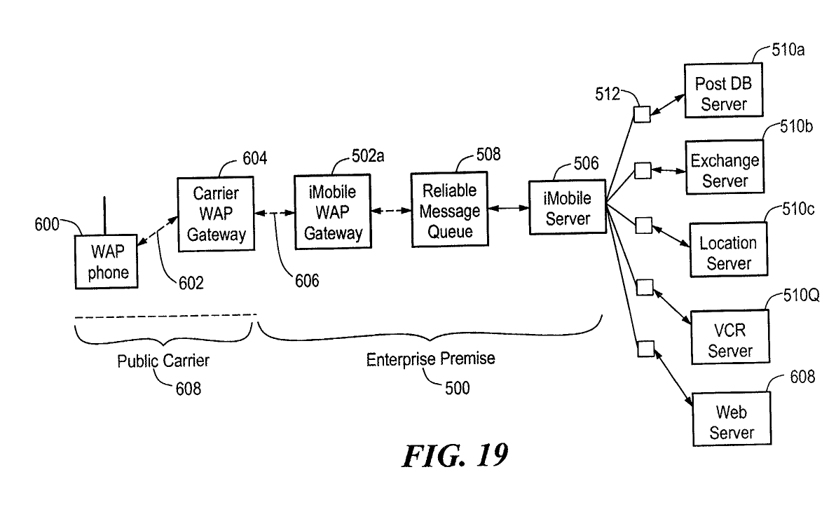

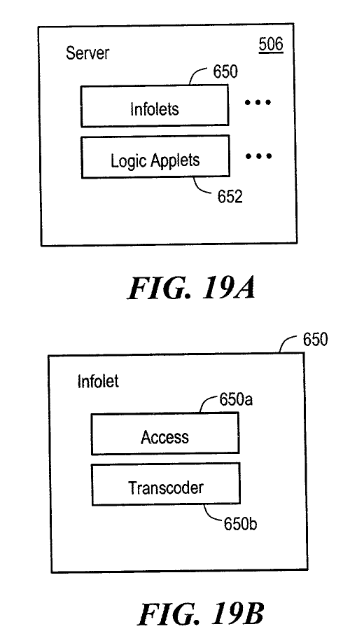

In a further aspect of the invention illustrated in FIG. 19, the HTTP gateway 502a (FIG. 17) can include enhanced security features. In the WAP model, the mobile device 600 has embedded browser software that connects to a WAP Gateway 604 (software infrastructure residing in the operator's Network that optimizes the transmission of content for the wireless network) and makes requests for information from a web server 608 in the form of an URL. As is known in the art, the content is formatted for the mobile phone's 600 relatively small screen and low bandwidth/high latency connection. Content is typically written in a markup language known as WML (Wireless Markup Language) and hosted on regular Web servers.

Conventionally, the access of web content from a WAP device actually involves two sessions. A first session between the mobile device and the WAP gateway and a second session between the WAP gateway and the web server. Even though Wireless Transport Layer Security (WTLS), for example, can be used between the mobile device and the WAP gateway, there is still potentially a security gap between the WAP gateway and the Web server unless both are hosted under the same authoritative domain or end-to-end encryption can be guaranteed.

Referring again to FIG. 19, there is shown an exemplary iMobile HTTP/WAP gateway 502a implementation in which the gateway is located on a security perimeter. A session 602 is created between the mobile device 600 and the carrier WAP gateway 604. The iMobile WAP gateway 502a interacts with the carrier's WAP gateway 604 and the iMobile message queue 508. The iMobile gateway 502a hosts WML files and allows only HTTP traffic from the carrier's gateway 604, while the message queue 508 allows only WAP service requests to be placed from the iMobile gateway 604. This separation shields the enterprise network/premise 500 from outside attacks aimed at the iMobile HTTP/WAP gateway 502a. However, the system 500 can continue to limit sensitive information from being delivered through WAP until a secure secret channel is established between the carrier's WAP gateway 604 and the iMobile gateway 502a.

Referring again to FIG. 17, the iMobile email gateway 502c allows mobile users 504 to access corporate services from a corporate email account by sending service requests as emails to an iMobile email account. The iMobile gateway 502c periodically checks that email account for service requests in the message queue 508 and returns results as emails to the requesting mobile user. A mobile user should have VPN (Virtual Private Network) support, for example, on the mobile device to guarantee the secrecy of corporate emails. In an alternative embodiment, as shown in FIG. 17B, mobile devices 550, such as Blackberry pagers, can be utilized that allow encryption keys to be stored on the devices and allow end-to-end encryption between the devices and a Blackberry enterprise server 552 (or a desktop redirector), which forwards emails to the corporate Microsoft Exchange email server 510b (FIG. 17). The Blackberry enterprise server 552 can be coupled to a mail server 554 and an iMobile system 556, which includes an email devlet 556a. The Blackberry enterprise server 552 is coupled to the Internet 558 via a firewall 770. A two-way paging network 572 serves the mobile devices 550.

The AIM gateway 502b includes an iMobile AIM devlet that acts like an AIM client, but interprets instant messages received as service requests and return responses as instant messages. In one embodiment, the iMobile AIM gateway 502b maps an AIM screen ID to an iMobile ID before submitting a service request. Due to the security limitations of conventional AIM channels (lack of encryption and insecure passwords), access to corporate data may be prohibited. It is understood that secure corporate instant messaging products, such as AT&T's IM Anywhere, that include end-to-end encryption among instant messaging clients can be utilized.

The iMobile Telnet gateway 502N allows iMobile users to log on to the iMobile platform 500 and access services as if they were regular Unix commands. This interface allows iMobile administrators to manage the iMobile system and mobile users to update account information using an admin infolet, for example. The mobile users 504 on the public Internet can use a mechanism, such as VPN, to get back on their intranet in order to have access to the Telnet Gateway 502N.

The message queue 508 provides a mechanism that enables replications of iMobile servers 506 to provide scalable services. In one particular embodiment, the message queue 508 utilizes the Java Message Service (JMS). The JMS API supports both point-to-point and publish/subscribe messaging approaches among distributed applications. In one particular embodiment, the iMobile system 500 uses the point-to-point (PTP) approach, in which an application is built around the concept of message queues, senders, and receivers. Each message is addressed to a specific queue, and receiving clients extract messages from the queue that holds their messages. In an exemplary embodiment, requests and connectionless replies transition on the message queue using UDP (User Datagram Protocol).

In an exemplary embodiment, the iMobile system 500 allocates three queues in the JMS provider: imobile.request, imobile.reply, and imobile.routed. Exemplary JMS providers include IBM MQ Series, Fiorano, and SonicMQ. Multiple gateways can place service requests on the imobile.request queue, while multiple iMobile servers 506 can pick up messages from the same queue. Similarly, servers 506 place responses on the imobile.reply queue, but only the originating gateways 502 can pick up the messages. The routed queue is used when an interactive session, which is described below, is involved so that subsequent requests from the same gateway are always routed to the same server.

It is understood that with this arrangement of iMobile gateways 502 and servers 506, the system can hot swap from one JMS provider context to the other without shutting down the platform. The use of an enterprise message service also provides a scalable platform with high availability and flexibility in both gateway and server configurations. A cluster of JMS providers can be used if necessary to increase the availability and scalability of the messaging service.

In general, and as illustrated in FIG. 19A, each iMobile server 506 can host a set of infolets 650 and logic components or applets 652 that provide connection to various services, such as backend databases, mail, directory, content, video, and home network servers. Each infolet 650 typically performs certain functions. For example, the infolets 650 provide a protocol interface to an information space: JDBC is used to access a corporate database, LDAP is used to access a directory, HTTP is used to access Web content, and X10 is used to control home devices like X10 cameras, etc.

As shown in FIG. 19B and described above, an infolet 650 can also include an access component 650a and a transcoding component 650b to perform transcoding so that the returned raw content, if any, is then transcoded according to one of the MIME types accepted by the receiving device. The iMobile system can support a variety of transcoder forms. Generally, the iMobile infolets 650 convert the raw information retrieved into transcodable objects that encapsulate the essential abstract information of the content or service. In general, infolets can also communicate with each other in accordance with a prescribed sequence of operation.

For example, while composing a message inside an Exchange infolet, a user can invoke the LDAP infolet to look up email addresses of certain recipients. While using the LDAP infolet to get the email address of a certain employee, a user may decide to invoke the Exchange infolet to send email to that employee.

The MIME type specified by the service request then dictates the transcoding process. Transcodable objects are frequently used on Web contents over which there is no control or access to the original data source, such as stock quotes and language translation services that are outside the corporate domain. In addition, XML (extensible Markup Language) has become increasingly popular as the return type of many Web services that support protocols like WebDAV. In one embodiment, iMobile supports several transcoders based on XML and XSLT (XML translation technology).

In an illustrative embodiment, the iMobile system can include image adaptation tools, such as Image Adapt tool from Newstakes.com, to adjust image sizes and quality according to device profiles.

Referring again to FIG. 17, the VCR infolet 510Q allows mobile users 504 to remotely record TV programs from any mobile device. The video can be stored on a VCR server in MPEG-2 and then transcoded to so-called H.263 format for low-bit rate adaptive wireless delivery through a video server.

Further infolets can provide generic HTML transcoding for taking any HTML page and converting it to a form suitable for display on mobile devices. The transcoder filters out complex objects such as JavasScripts, replaces embedded images with hyperlinks, and splits long HTML pages into several pages. It also preserves most HML forms and allows simple interactions even on small browsers on PDA's or WAP phones.

It is understood that an iMobile applet 652 (FIG. 19A) may invoke several infolets 650 to complete a complex task or implement business logic. For example, the find infolet, which allows mobile users to find a store near the location of the mobile user, invokes the location infolet, which interfaces with a location determination technology, followed by an interface with a yellow page infolet to report the store near the mobile user.

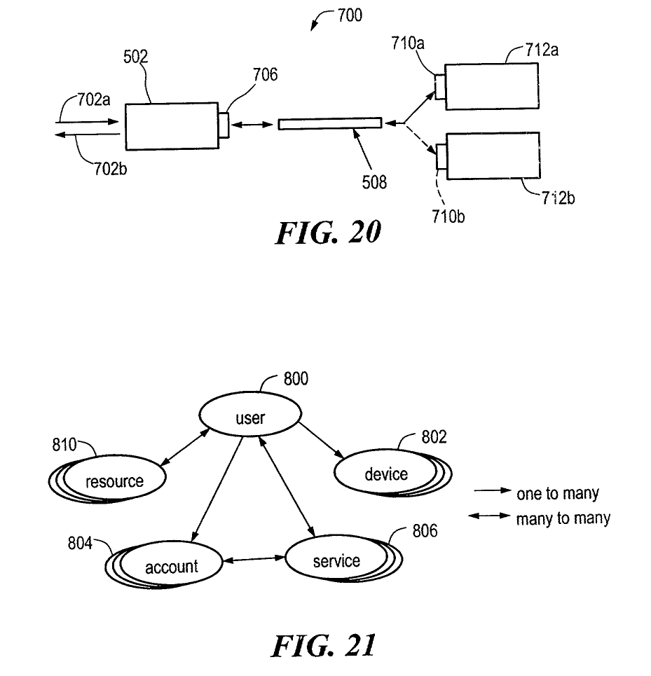

FIG. 20, in conjunction with FIG. 17, shows an exemplary session management diagram 700 for an iMobile system 500 in accordance with the present invention. In the above discussion, it was assumed that any iMobile server 506a-P can pick up any iMobile service request placed on the message queue 508 by any gateway 502a-N. For infolets that require maintenance of context during a dialog session, the iMobile system 500 can ensure that the requests that belong to the same session are routed to the same server. Routing information can be embedded into reply information placed in the message queue. Exemplary routing information includes server name and queue information.

Upon successful completion of user authentication after a mobile user request/reply 702a,b, the gateway 502 creates a new front-end session with a unique identification tag via a front-end dispatcher module 706. In one embodiment, the front-end session is valid during the lifetime of mobile user interaction with the iMobile system 500 through this gateway 502. Each protocol-specific request is transformed into a standard iMobile request on the message queue 508 that carries the front-end session identification tag. If a particular service, such as the natural language dialog service Eliza, requires session management for subsequent requests, then a back-end session is created via a backend dispatcher module 710 and is identified by the same identification tag used in the front-end session. In one embodiment, back-end dispatchers 710a,b are provided as part of server and infolet containers 712a,b.

It is understood that most requests are stateless, e.g., request data, process request, and return data, and so do not require session management. Such requests are generally server independent. However, state information must be retained for certain applications, such as dialog services. Dialog services require that the server keep track of each user interaction so as to provide a dialog that makes sense. In addition, the dialog occurs with one server at any one time so that the data should flow to the server with which the dialog was initiated.

In an exemplary embodiment, the back-end session is valid for the server in which it was created and it is not available for use by other servers in the iMobile server cluster. For this reason, the system 500 should guarantee that subsequent service requests of the same type from the same user are sent to the same server. This is achieved by enabling the request routing feature during the first reply, following the creation of a back-end session.

The routing information, e.g., the server name and the routed-request queue identifier, is embedded by the server-side dispatcher 710 into the reply message. This information is picked up by the front-end dispatcher 706 and stored in the front-end session. Subsequent requests generated under this front-end session are sent based on the routing information and are guaranteed to be picked up by the same server. This information is valid only while the requests are sent to the same service. In one embodiment, the information is destroyed as soon as the user invokes another service. This behavior is notable because request routing interferes with the so-called round-robin request distribution dictated by the queuing policy of JMS. Moreover, system messages need to be exchanged between the gateway 502 and the server 712a to clean up back-end sessions when a front-end session is dismissed. Alternatively, the server that runs the back-end session can employ a time-out mechanism.

In an illustrative embodiment, the service profile database 514 (FIG. 17 is a relational database with an Entity-Relationship data model that includes services, users, devices, permissions, protocols, authoritative domains, etc., that govern all aspects of the operation of the iMobile system. iMobile system administrators can populate the database 514 during the system startup or the user provisioning process. In one particular embodiment, the system 500 uses a Cloudscape database from IBM (formerly Informix). However, the system can easily migrate to other relational database system since SQL can be used, which is the standard query language for relational databases. The database allows user provisioning. Each user is allowed to add different accounts (HTTP, AIM, TELNET etc.) and modify the user's profile properties.

FIG. 21 shows a subset of the entities and relationships in a data model that can be used for a mobile device server in accordance with the present invention. Each user 800 has a unique user id in the iMobile system, but it may own multiple devices 802 and accounts 804 (such as an AIM screen name, a telnet account or an Exchange email account) for access to the iMobile system and various backend services 806. Only a single user is allowed to own each device or account. A user also has access to a set of resources 810 (X10 cameras, VCR, etc.), but multiple users can share the same resource. Similarly, a user 800 is allowed to access multiple services 806 through corresponding accounts 804. For example, the windows domain account can be used to access the inbox, calendar, and contacts in the Microsoft Exchange 2000 Server. When iMobile is set up to use Single Sign On (SSO), a user will be authenticated through the iMobile gateway. An iMobile server will pick up the request from the message queue and check to see whether it is a service on an Exchange inbox, calendar, or contacts. If so, it retrieves the encrypted Windows domain authentication information from the profile database and presents it to the Exchange server.

The iMobile system can also support the transcoding of services for Microsoft Exchange. As is well known to one of ordinary skill in the art, Microsoft Exchange 2000 servers 510b (FIG. 17) support remote access through the Web Distributed Authoring and Versioning (WebDAV) protocol. WebDAV extends the HTTP 1.1 protocol to support remote collaborative authoring of network resources of any media type. Exemplary methods added to WebDAV that use XML as the request and response format include: PROPFIND (property retrieval), PROPPATCH (set and remove properties), and MKCOL (make a new resource collection). The Exchange server 510b also supports DAV Searching & Locating (DASL), which employs HTTP 1.1 to form a lightweight search protocol to transport queries and result sets. It also allows clients to make use of server-side search facilities using the SEARCH method.

It is understood that iMobile Exchange infolets can use these HTTP extensions to query, search, and update inboxes, contacts, and calendars in the Exchange 2000 server. For example, the following PROPFIND method will return the Sender, Subject and Date Received in all the messages in the Exchange inbox of a user named Huale:

PROPFIND/exchange/huale/inbox HTTP/1.1
Content-Type:text/xml; charset=“utf-8”
Content-Length:XXX
Depth: 1
<?xml version=“1.0” encoding=\“utf-8/”?>
<D:propfind xmlns:D=“DAV:” xmlns:E=“urn:schemas:httpmail:”>
<D:prop>
<E:sender/>
<E:subject/>
<E:datereceived/>
</D :prop>
</D:propfind>

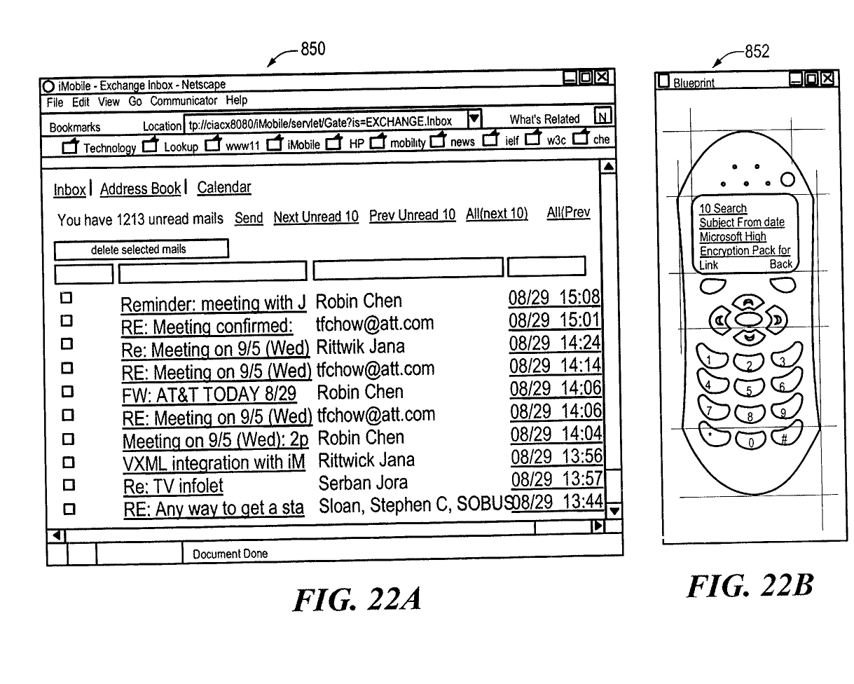

Once the XML response is returned, the Exchange infolet then invokes Xalan (an XSLT stylesheet processor) to transcode the XML content to the appropriate MIME type for the receiving device. FIGS. 22A-B show Microsoft Exchange inboxes displayed on respective form factors/devices 850,852.

In another aspect of the invention, the iMobile system also provides personalized multimedia services. It enables a mobile user to remotely record video programs, control cameras, and request the delivery of pre-recorded or live video content to a mobile device, etc. The iMobile system authenticates users who send service requests from various mobile devices, transcodes video content based on user and device profiles, and authorizes the delivery of content from the iVideo media server to the proper client device. iVideo is shown and described in pending U.S. patent application Ser. No. 10/136,540, filed on May 1, 2002, which is incorporated herein by reference. The media server adapts automatically to the fluctuations of the wireless channel conditions for reasonable viewing on the client device. The mobile service platform essentially manages the control path, while the media server handles the actual content delivery. An exemplary system includes integrated iMobile and iVideo features useful on wireless LAN and Cellular Digital Packet Data (CDPD) networks.

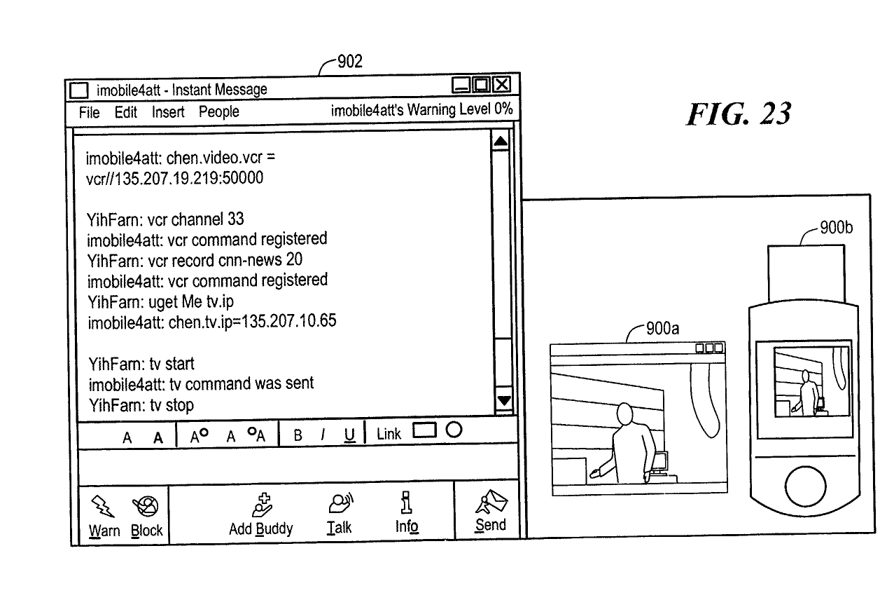

FIG. 23 shows illustrative remote control and video delivery to respective wirelessly connected mobile devices 900a,b from an AIM client 902. As can be seen in the AIM client display 902, the user first sets the channel on the VCR server to 33 (CNN) and then requests a 20-second segment to be recorded in a file called cnn-news. The user then verifies that the tv.ip property in the profile matches the IP address of the user's iPAQ device and requests the delivery of pre-recorded video, live TV, or camera views to the user's iPAQ device.

In one embodiment, the iMobile system controls multimedia delivery from dedicated servers in which the video servers are personal and are under the control of a few people, usually at a home or in a small business environment. Even though the access authorization of these video sources is controlled by iMobile, it is essentially still operating in a peer-to-peer mode between the mobile device and the video server.

In an alternative embodiment, an iMobile system includes multipoint-to-multipoint distribution for enhancing the availability of the video sources to end clients. In one particular embodiment, the so-called MBONE architecture can be used.

The present invention provides an enterprise mobile service platform for enabling mobile devices to communicate with each other and to securely access corporate and Internet content and services. Exemplary features include allowing mobile users to interact with iMobile through AOL's instant messaging service. Popular services include pq, a corporate directory service, quote, a stock quote service, and location-aware services such as location, find, and weather. Another service accesses Microsoft Exchange 2000 email, calendar, and address book.

### EXAMPLE

An initial load testing iMobile system includes three gateways and three servers running on various Red Hat Linux, SGI Irix, Sun Solaris and Microsoft Windows machines. About 120 concurrent threads were started that generated load for the three gateways. Each thread executes 50 service requests with a random delay between requests of 0 to 20 seconds. The iMobile gateways and servers were able to finish all 6000 requests in about 9 minutes. The round-trip delay of each request between the client and the iMobile server was tested using the Echo infolet, which simply responds with whatever the mobile user sends without invoking any external service. The delay was in the range of 69 ms (milliseconds) to 204 ms with an average of 105.35 ms. Table 1 below gives more complete test results based on different kinds of service requests.

| | | | | | Req. | Avg. |
|---|---|---|---|---|---|---|
| | | | | Num. Req. | Arrival | Round |
| | Num. | Num. | Num. | Per | Interval | Trip Delay |
| Queries | Gateways | Servers | Threads | Thread | (sec) | (ms) |
| Echo | 3 | 3 | 120 | 50 | 0-20 | 105.35 |
| Post | 3 | 3 | 30 | 20 | 0-20 | 715.03 |
| Query | | | | | | |
| MSN | 3 | 3 | 30 | 20 | 0-20 | 423.30 |
| Quote | | | | | | |
| Microsoft | 3 | 3 | 30 | 20 | 0-20 | 931.60 |
| Exchange | | | | | | |

An exemplary iMobile architecture conforms to design specifications already popular in Java enterprise applications, such as JMS, JDBC, JNDI, Servlet, WebDAV, XSLT, and XML. This allows iMobile to interface with a broad spectrum of products used in the enterprise world; ideally. In one embodiment, iMobile can be an add-on over an existing infrastructure in an enterprise.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A mobile device server system for processing data requests from mobile devices, comprising:
a plurality of gateways for interfacing with the mobile devices, the plurality of gateways supporting respective mobile device types and protocols;
a plurality of servers for servicing requests from the mobile devices for data from external information sources; and
a message queue for storing requests from the plurality of gateways and replies from the plurality of servers.

2. The system according to claim 1, wherein the plurality of gateways each include at least one interface component for providing an interface to the mobile devices.

3. The system according to claim 1, wherein the plurality of servers each include one or more of an access component for accessing at least one of the external information sources and a logic component for processing information retrieved from the external information source.

4. The system according to claim 1, wherein the plurality of gateways include gateways for supporting HTTP, AIM, E-mail, Telnet, ICQ, SMS, WAP, SMTP, IMAP, POP3, and VXML.

5. The system according to claim 1, wherein the plurality of servers include servers for interfacing with external information sources including one of more of Post DB, Exchange, location servers, VCR servers, ODBC, JDBC, CORBA, HTTP, X10, email, and XML.

6. The system according to claim 1, further including a service module for providing at least one of authentication, authorization, and accounting.

7. The system according to claim 1, further including a service profile database for storing transcoding and content delivery information.

8. The system according to claim 1, wherein a number of active ones of the plurality of gateways is based upon traffic load.

9. The system according to claim 1, wherein each of the plurality of gateways implements a particular protocol.

10. The system according to claim 1, further including an authentication system for authenticating the mobile devices.

11. The system according to claim 1, further including a single sign-on mechanism.

12. The system according to 1, further including an interface for adding/modifying a user's profile properties.

13. The system according to claim 1, wherein each of the plurality of servers transcodes data from the external information source to a MIME type supported by a recipient one of the mobile devices.

14. The system according to claim 1, further including an image adaptation mechanism for adjusting information for a recipient one of the mobile devices.

15. A method of enabling communication for a plurality of mobile device types, comprising:
receiving data requests from the mobile devices with a plurality of gateways;
placing information of the received data requests on a message queue by the gateways;
retrieving the message queue information with a plurality of servers for interfacing with a plurality of external information sources;
placing reply information from the servers on the message queue; and
sending the reply information to the mobile devices via the gateways.

16. The method according to claim 15, further including activating a number of the plurality of gateways based upon a traffic load.

17. The method according to claim 15, further including providing respective ones of the gateways for supporting HTTP, AIM, E-mail, Telnet, ICQ, SMS, XMS, WAP, SMTP, IMAP, POP3, and IVR.

18. The method according to claim 15, further including interfacing with the plurality of external information sources including one or more of Post DB, Exchange servers, location servers, VCR servers, ODBC, JDBC, CORBA, http, X10, email, and XML.

19. The method according to claim 15, further including
generating a first session between a first one of the plurality of mobile devices and a first one of the plurality of gateways; and
limiting information that can be placed on the message queue to provide security for the first one of the plurality of gateways.

20. The method according to claim 19, further including providing a secure channel from an external gateway supporting the first one of the plurality of mobile devices and the first one of the plurality of gateways.

21. The method according to claim 20, wherein the external gateway is a WAP gateway.

22. The method according to claim 15, further including
generating a front-end session by a first one of the plurality of gateways associated with a first one of the plurality of mobile devices;
transforming a request from the first one of the mobile devices to a corresponding one of a plurality of predetermined requests; and
generating a back-end session associated with a first one of the plurality of servers handling the request from the first one of the mobile devices.

23. The method according to claim 22, further including identifying the front-end session with a first tag.

24. The method according to claim 23, further including identifying the back-end session with the first tag.

25. The method according to claim 22, further including generating a front-end dispatcher for creating the front-end session.

26. The method according to claim 25, further including generating a back-end dispatcher for creating the back-end session.

27. The method according to claim 22, further including embedding routing information into reply information placed in the message queue.

28. The method according to claim 27, wherein the routing information includes server name information and queue information.

29. The method according to claim 15, further including authenticating the mobile users.
